(19) United States
(12) Patent Application Publication
(10) Pub. No.: US 2013/0171874 A1
(43) Pub. Date: Jul. 4, 2013

(54) CONNECTOR HAVING FILTERING MODULE

(71) Applicant: KUAN-HSIUNG WEI, Taipei City (TW)

(72) Inventor: KUAN-HSIUNG WEI, Taipei City (TW)

(21) Appl. No.: 13/342,928

(22) Filed: Jan. 3, 2012

(51) Int. Cl. H01R 13/66

(52) U.S. Cl. 439/620.1

(57) ABSTRACT

The connector contains a port member, a base board electrically connected to the port member, and a filtering module electrically connected to the base board. The filtering module contains a number of vertically stacked circuit boards. There are a number of layout areas on each circuit board. Between a pair of adjacent circuit boards, an amorphous ring core is configured correspondingly to each layout area. Through the conduction between the amorphous ring core and the circuits in the layout areas, the amorphous ring cores are capable of filtering. The connector does not require manual winding, and have advantages such as stable quality and reduced production time.

### TECHNICAL FIELD OF THE INVENTION

The present invention is generally related to connectors, and more particular to a connector with a built-in filtering module.

### DESCRIPTION OF THE PRIOR ART

Various connectors are widely used in electronic appliances and industrial apparatus. The connectors provide electrical connection upon which information and/or electricity is delivered. There are connectors with built-in filtering module such as the RJ connectors. This kind of connectors usually contains a port member, a base board, and a filtering module. The filtering module usually consists of a number of coils, each containing a ferrite ring core with windings by conductive wires.

As shown in FIG. 4, a conventional filtering module 3 contains a number of coils manually wound around a ferrite ring core 31 so as to provide the filtering function.

Such filtering modules have a number of disadvantages. For example, the windings for the ferrite ring core 31 have to be achieved manually which leads to long production time and instable quality.

### SUMMARY OF THE INVENTION

A major objective of the present invention is to adopt amorphous ring core so as to obviate manual winding and to achieve enhanced quality and short production time.

Another objective of the present invention is to achieve reduced magnetic impedance for high-frequency applications by winding a conductive wire on the amorphous core ring.

To achieve the above objectives, the connector contains a port member, a base board electrically connected to the port member, and a filtering module electrically connected to the base board. The filtering module contains a number of vertically stacked circuit boards. There are a number of layout areas on each circuit board. Between a pair of adjacent circuit boards, an amorphous ring core is configured correspondingly to each layout area. Through the conduction between the amorphous ring core and the circuits in the layout areas, the amorphous ring core is capable of filtering. The amorphous ring core does not require manual winding, and have advantages such as stable quality and reduced production time.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a connector according to an embodiment of the present invention.

FIG. 2 is a perspective diagram showing a filtering module of the connector of FIG. 1.

FIG. 3 is a perspective diagram showing an RJ plug is plugged into the connector of FIG. 1.

FIG. 4 is a perspective diagram showing a conventional coil-based filtering module

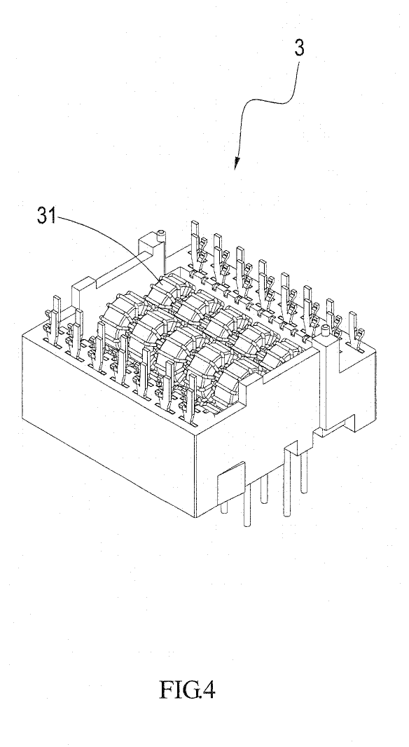

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

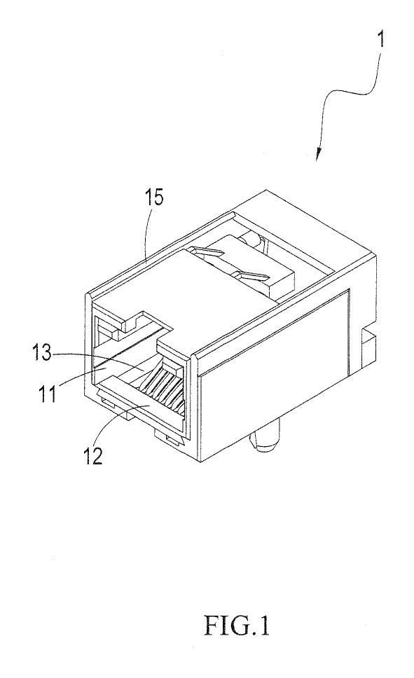

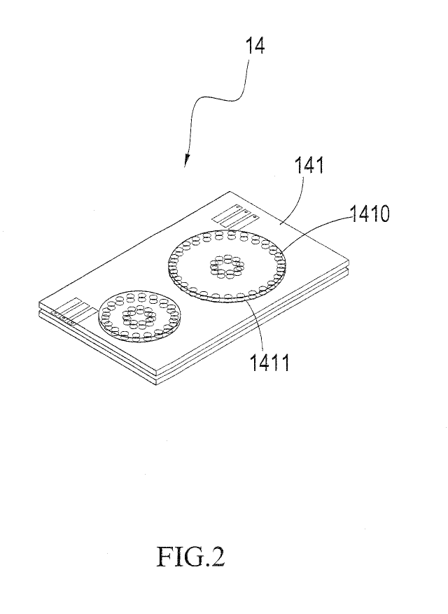

As shown in FIGS. 1 and 2, a connector 1 according to an embodiment of the present invention contains an insulating base member 11, a port member 12 received by the base member 11 and capable of receiving an RJ plug, a base board 13 electrically connected to the port member 12, and a filtering module 14 electrically connected to the base board 13.

The filtering module 14 contains at a number of vertically stacked circuit board 141. There are a number of layout areas 1410 on each circuit board 141. Between a pair of the circuit boards 141, an amorphous ring core 1411 is configured correspondingly to each layout area 1410.

Additionally, the insulating base member 11 is housed inside a shielding case member 15.

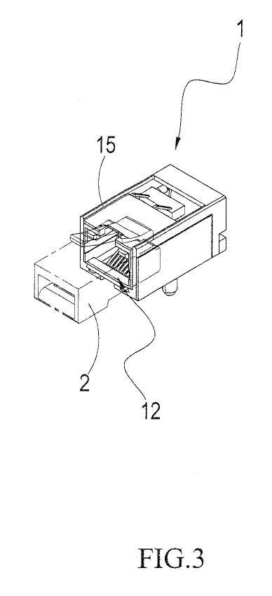

As shown in FIG. 3, a plug 2 is plugged into the port member 12 of the connector 1. Since the port member 12 is electrically connected to the base board 13, which in turn is electrically connected to the filtering module 14, the plug 2 is electrically connected to the filtering module 14. The filtering module 14 contains a least a pair of circuit boards 141 stacked together. For each pair of adjacent circuit boards 141, at least an amorphous ring core 1411 is configured. The assembly of the filtering module 14 is as follows. Firstly, solder is placed in a layout area 1410 of a circuit board 141 and, then, an amorphous ring core 1411 is placed on the layout area 1410. Finally, another circuit board 141 is stacked and a high-temperature process is conducted. The filtering module 14 is the completed.

The present invention has the following advantages compared to the prior art.

Firstly, no manual winding is required.

Secondly, the production quality is enhanced and stable.

Thirdly, the production time is reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector, comprising:
a port member;
a base board electrically connected to said port member; and
a filtering module electrically connected to said base board;
wherein said filtering module comprises at least a pair of stacked circuit boards each having at least a layout area; and at least an amorphous ring core configured between adjacent circuit boards correspondingly to each layout area.

2. The connector according to claim 1, wherein said port member is capable of receiving an RJ plug.

3. The connector according to claim 1, further comprising an insulating base member receiving said port member; said base board, and said filtering module.

4. The connector according to claim 3, wherein said base member is housed in a shielding casing.
